(19) United States
(12) Patent Application Publication
(10) Pub. No.: US 2022/0152449 A1
(43) Pub. Date: May 19, 2022

(54) YOGA MAT

(71) Applicant: Wei-Ting CHIEN, Changhua County (TW)

(72) Inventor: Wei-Ting CHIEN, Changhua County (TW)

(21) Appl. No.: 16/951,411

(22) Filed: Nov. 18, 2020

(51) Int. Cl. A63B 21/00

(52) U.S. Cl. CPC A63B 21/4037; A63B 2209/023

(57) ABSTRACT

A yoga mat is provided, including: a cushion body, including at least one first thread and at least one second thread, at least one functioned thread of the at least one first thread being woven by a plurality of filaments and at least one rubber filament, the at least one rubber filament being at least partially exposed on an outer surface of the at least one functioned thread.

### BACKGROUND OF THE INVENTION

### Field of the Invention

The present invention relates to a yoga mat.

### Description of the Prior Art

Nowadays, people pay more and more attention to physical health, so they will engage in various sports after class or after work. Yoga is a relatively static exercise and requires less space; however, it can still effectively relax the body and mind and reach health. Therefore, more and more people engage in yoga. Because the floor is hard, a yoga mat is usually used for cushioning during yoga. The yoga mat disclosed in TWM485813 is made of ethylene-vinyl acetate (EVA) copolymer by foaming, which can achieve cushioning and anti-slip effects.

However, because the above-mentioned conventional yoga mat is made of plastic, its air permeability is low and it is uncomfortable in touch or contact. As to a yoga mat made of woven cloth, the yoga mat is easy to slip due to insufficient friction between the woven cloth and the floor, causing safety problems in operation.

The present invention is, therefore, arisen to obviate or at least mitigate the above-mentioned disadvantages.

### SUMMARY OF THE INVENTION

The main object of the present invention is to provide a yoga mat which provides higher contact friction for avoiding slippage on the cushion body 1 relative to the user and the surface on which the yoga mat is disposed.

To achieve the above and other objects, a yoga mat is provided, including: a cushion body, including at least one first thread and at least one second thread, at least one functioned thread of the at least one first thread being woven by a plurality of filaments and at least one rubber filament, the at least one rubber filament being at least partially exposed on an outer surface of the at least one functioned thread.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a side view of a preferable embodiment of the present invention;

FIG. 2 is a partial enlargement of a second thread of a preferable embodiment of the present invention; and

FIG. 3 is a side view of another preferable embodiment of the present invention.

### DETAILED DESCRIPTION OF THE PREFERRED EMBODIMENTS

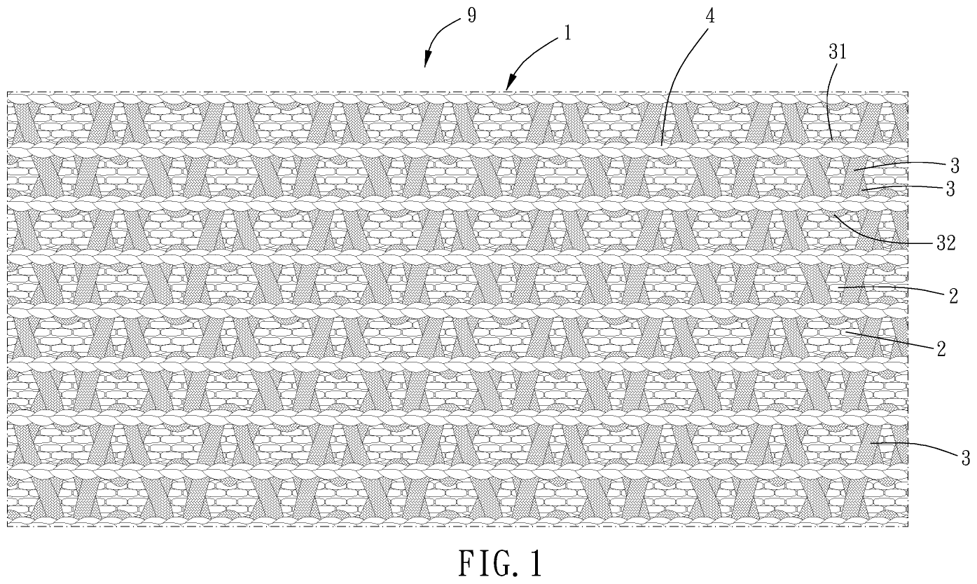

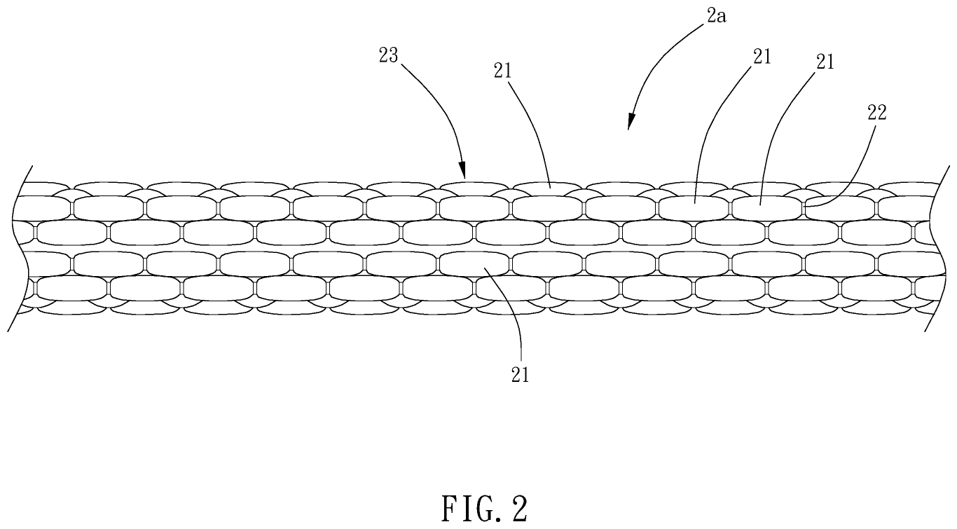

Please refer to FIGS. 1 to 2 for a preferable embodiment of the present invention. A yoga mat 9 of the present invention includes a cushion body 1.

The cushion body 1 includes at least one first thread 2 and at least one second thread 3, at least one functioned thread 2a of at least one the first thread 2 is woven by a plurality of filaments and at least one rubber filament 21, and the at least one rubber filament 21 is at least partially exposed on an outer surface of the first thread 2.

Since the cushion body 1 are woven by the at least one first thread 2 and the at least one second thread 3, it provides woven textile tactile feeling and good artistic quality. The at least one rubber filament 21 of the at least one functioned thread 2a of is at least partially exposed, which provides higher contact friction for avoiding slippage on the cushion body 1 relative to the user and the surface on which the yoga mat is disposed.

In this embodiment, the at least one first thread includes a plurality of first threads 2 and the at least one second thread includes a plurality of second threads 3, and each of the plurality of first threads 2 includes a plurality of said rubber filaments 21. The plurality of first threads 2 extend along a first direction, and the plurality of second threads 3 extend along a direction non-parallel to the first direction. In other embodiments, the plurality of second threads extend along a direction lateral to a direction in which the plurality of first threads extend. The rubber filament 21 is made of latex, polyurethane elastomer rubber (TPU) or thermoplastic elastomer (TPE). In this embodiment, the rubber filament 21 is made of latex. The plurality of second threads 3 is woven by a plurality of filaments.

Specifically, each of the plurality of second threads 3 extends windingly in the first direction and includes a plurality of wave crest portions 31 and a plurality of wave trough portions 32 which are arranged alternatively, and each said wave crest portion 31 of one of the plurality of second threads 3 is overlapped with one said wave trough portion 32 of another one of the plurality of second threads 3.

Preferably, the yoga mat 9 further includes a plurality of binding threads 4, the plurality of binding threads 4 are arranged in intervals and woven with the plurality of first threads 2 and the plurality of second threads 3, so as to tie the plurality of first threads 2 and the plurality of second threads 3. The plurality of binding threads 4 are woven by a plurality of filament. In this embodiment, the plurality of binding threads 4 extends in the first direction; however, the plurality of binding threads may extend in a direction lateral or oblique to the first direction.

The at least one first thread 2 is formed by woven, and each said rubber filament 21 of the at least one functioned thread 2a is tied by part of the plurality of filaments of the at least one functioned thread 2a so as to form a non-flat structure 23 of an outer surface of the cushion body 1. Specific, the first thread 2 includes a plurality of tying filaments 22 which tie and radially contract each said rubber filament 21 in a direction lateral to the first direction so that each said first thread 2 has a non-flat outer surface to include the non-flat structure 23, which is pretty slipping-proof.

Preferably, the at least one rubber filament 21 is in stretched state and woven with the plurality of filaments of the at least one functioned thread 2a, which can avoid the stretch of the cushion body 1 during using so that it is very safe.

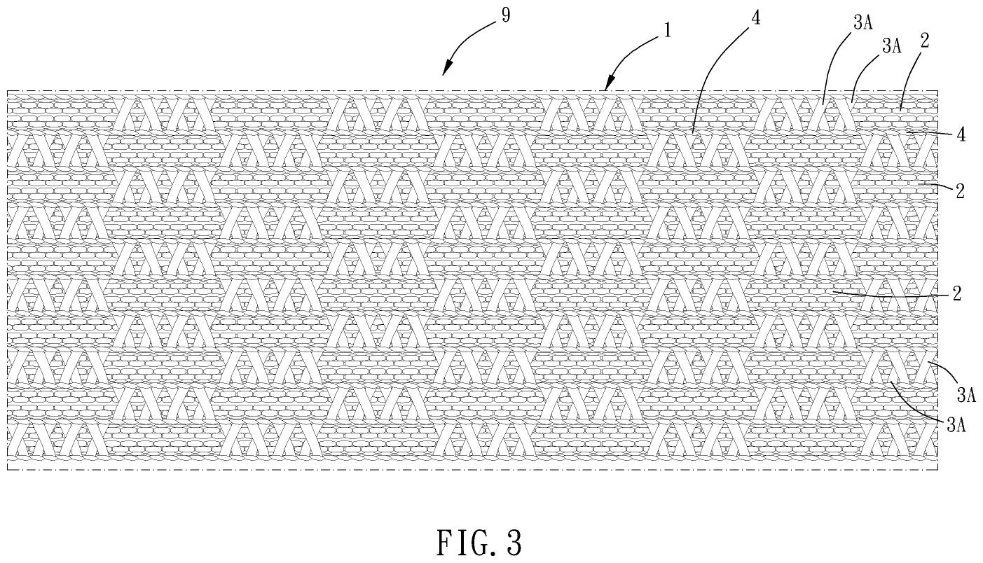

In an alternative embodiment as shown in FIG. 3, the plurality of second threads 3A extend obliquely relative to the first direction and are interlaced with and between the plurality of first threads 2, and parts of the plurality of second threads 3A are crossly overlapped so that large area of the plurality of first threads 2 can be exposed on two side faces of the cushion body 1.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A yoga mat, including:
a cushion body, including at least one first thread and at least one second thread, at least one functioned thread of the at least one first thread being woven by a plurality of filaments and at least one rubber filament, the at least one rubber filament being at least partially exposed on an outer surface of the at least one functioned thread.

2. The yoga mat of claim 1, wherein the at least one first thread includes a plurality of first threads, the at least one second thread includes a plurality of second threads, the plurality of first threads extend along a first direction, and the plurality of second threads extend along a direction non-parallel to the first direction.

3. The yoga mat of claim 2, wherein each of the plurality of second threads extends windingly in the first direction and includes a plurality of wave crest portions and a plurality of wave trough portions which are arranged alternatively.

4. The yoga mat of claim 3, wherein each said wave crest portion of one of the plurality of second threads is overlapped with one said wave trough portion of another one of the plurality of second threads.

5. The yoga mat of claim 2, further including a plurality of binding threads, wherein the plurality of binding threads are arranged in intervals and woven with the plurality of first threads and the plurality of second threads, the plurality of binding threads are woven by a plurality of filament, and the plurality of binding threads extends in the first direction.

6. The yoga mat of claim 2, wherein the plurality of filaments of the at least one functioned thread includes a plurality of tying filaments which tie and radially contract each said rubber filament in a direction lateral to the first direction so that each said first thread has non-flat outer surface.

7. The yoga mat of claim 1, wherein the at least one first thread is formed by woven, and each said rubber filament of the at least one functioned thread is tied by part of the plurality of filaments of the at least one functioned thread so as to form a non-flat structure of an outer surface of the cushion body.

8. The yoga mat of claim 1, wherein the at least one rubber filament is in stretched state and woven with the plurality of filaments of the at least one functioned thread.

9. The yoga mat of claim 4, wherein the yoga mat further includes a plurality of binding threads, the plurality of binding threads are arranged in intervals and woven with the plurality of first threads and the plurality of second threads, the plurality of binding threads are woven by a plurality of filament, and the plurality of binding threads extends in the first direction; the first thread includes a plurality of tying filaments, the plurality of filaments of the at least one functioned thread includes a plurality of tying filaments which tie and radially contract each said rubber filament in a direction lateral to the first direction so that each said first thread has a non-flat outer surface; the at least one first thread is formed by woven, and each said rubber filament of the at least one functioned thread is tied by part of the plurality of filaments of the at least one functioned thread so as to form a non-flat structure of an outer surface of the cushion body; the at least one rubber filament is in stretched state and woven with the plurality of filaments of the at least one functioned thread; the rubber filament is made of latex, polyurethane elastomer rubber (TPU) or thermoplastic elastomer (TPE); each of the plurality of second threads is woven by a plurality of filaments.

10. The yoga mat of claim 5, wherein the plurality of filaments of the at least one functioned thread includes a plurality of tying filaments which tie and radially contract each said rubber filament in a direction lateral to the first direction so that each said first thread has non-flat outer surface; the at least one first thread is formed by woven, and each said rubber filament of the at least one functioned thread is tied by part of the plurality of filaments of the at least one functioned thread so as to form a non-flat structure of an outer surface of the cushion body; the at least one rubber filament is in stretched state and woven with the plurality of filaments of the at least one functioned thread; the rubber filament is made of latex, polyurethane elastomer rubber (TPU) or thermoplastic elastomer (TPE); each of the plurality of second threads is woven by a plurality of filaments, the plurality of second threads extend obliquely relative to the first direction and are interlaced with and between the plurality of first threads, and parts of the plurality of second threads are crossly overlapped.
